(19) United States
(12) Patent Application Publication
(10) Pub. No.: US 2009/0203310 A1
(43) Pub. Date: Aug. 13, 2009

(54) SUPERPOSITION TRANSMISSION AND DETECTION OF ACCESS AND BACKHAUL SIGNALS

(75) Inventors: Angel Lozano, Barcelona (ES); Reinaldo Valenzuela, Holmdel, US (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: LUCENT TECHNOLOGIES INC., Murray Hill, NJ (US)

(21) Appl. No.: 12/029,835

(22) Filed: Feb. 12, 2008

(51) Int. Cl. H04B 7/15

(52) U.S. Cl. 455/15

(57) ABSTRACT

According to one embodiment of the invention, a wireless communication system (WCS) has a wireless relay and a base station adapted to process wireless access traffic for one or more mobile terminals (MTs) and to process wireless backhaul traffic. The wireless relay is adapted to generate a superimposed signal having a backhaul component intended for the base station and an access component intended for one of the MTs. The wireless relay is further adapted to allocate power between the backhaul and access components based on signal propagation conditions between itself, the base station, and the MT to render the backhaul component decodable at the base station and the access component decodable at the MT.

### BACKGROUND OF THE INVENTION

1. Field of the Invention

The present invention relates to wireless communication systems and, more specifically, to wireless communication systems employing wireless relays.

2. Description of the Related Art

A typical wireless communication system (WCS) has a plurality of base stations connected via wireline links to a network, such as a public-switched telephone network (PSTN), a private telephone network, or the Internet. A mobile terminal (MT), such as a hand-held communication device or a laptop computer, connects wirelessly to one or more of the base stations. After the connection is established, the base station(s) can route communication signals to and from the MT, e.g., to support a communication link between the MT and a remote terminal.

Because deployment of base stations is relatively expensive, WCS operators may employ wireless relays in addition to base stations. A wireless relay is similar to a base station in that it can support wireless links with MTs. However, a wireless relay does not have a wireline link to the network and instead relies on wireless links to one or more of the base stations for its network connectivity. A wireless relay can connect to a base station either directly or via one or more other wireless relays. Depending on location, an MT can connect directly to either a base station or a wireless relay. In the latter case, the wireless relay uses its wireless link(s) to a corresponding base station to gain network access and enable communications between the MT and the network. Advantageously, the use of wireless relays enables WCS operators to expand their services at a fraction of the cost normally associated with the deployment of new base stations.

In a WCS employing wireless relays, wireless traffic can be differentiated into two categories: access traffic and backhaul traffic. Access traffic is composed of communication instances between (1) an MT and (2) a wireless relay or base station. Backhaul traffic is composed of communication instances between (1) a wireless relay and (2) a base station or another wireless relay. While, as already indicated above, the use of wireless relays can be beneficial, it forces some of the wireless resources to be allocated to backhaul traffic. The latter might disadvantageously reduce the availability of wireless resources to access traffic.

### SUMMARY OF THE INVENTION

According to one embodiment of the invention, a wireless communication system (WCS) has a wireless relay and a base station adapted to process wireless access traffic for one or more mobile terminals (MTs) and to process wireless backhaul traffic. The wireless relay is adapted to generate a superimposed signal having a backhaul component intended for the base station and an access component intended for one of the MTs. The wireless relay is further adapted to allocate power between the backhaul and access components based on signal propagation conditions between itself, the base station, and the MT to render the backhaul component decodable at the base station and the access component decodable at the MT. Advantageously, this WCS is capable of completing a typical uplink/downlink exchange between the wireless relay, base station, and MT using fewer resources, e.g., time slots, than a comparable prior-art WCS.

According to one embodiment, the present invention is, at a first transceiver of a WCS comprising a plurality of transceivers having one or more wireless relays and one or more base stations, at least one of said wireless relays and at least one of said base stations being adapted to process wireless access traffic and wireless backhaul traffic, a communication method comprising the steps of: (A) generating a superimposed signal having a backhaul component intended for a second transceiver and an access component intended for a mobile terminal; and (B) transmitting the generated superimposed signal.

According to another embodiment, the present invention is, at a first transceiver of a WCS comprising a plurality of transceivers having one or more wireless relays and one or more base stations, at least one of said wireless relays and at least one of said base stations being adapted to process wireless access traffic and wireless backhaul traffic, a communication method comprising the steps of: (A) receiving a superimposed signal having a backhaul component and an access component, said superimposed signal generated by (i) a second transceiver or (ii) by the second transceiver and another transceiver, with each of the second transceiver and said another transceiver generating a corresponding one of the backhaul and access components; and (B) decoding at least one of said backhaul and access components.

According to yet another embodiment, the present invention is a first transceiver of a WCS comprising a plurality of transceivers having one or more wireless relays and one or more base stations, at least one of said wireless relays and at least one of said base stations being adapted to process wireless access traffic and wireless backhaul traffic, said first transceiver characterized by being adapted to: (A) generate a superimposed signal having a backhaul component intended for a second transceiver and an access component intended for a mobile terminal; and (B) transmit the generated superimposed signal.

According to yet another embodiment, the present invention is a first transceiver of a WCS comprising a plurality of transceivers having one or more wireless relays and one or more base stations, at least one of said wireless relays and at least one of said base stations being adapted to process wireless access traffic and wireless backhaul traffic, said first transceiver characterized by being adapted to: (A) receive a superimposed signal having a backhaul component and an access component, said superimposed signal generated by (i) a second transceiver or (ii) by the second transceiver and another transceiver, with each of the second transceiver and said another transceiver generating a corresponding one of the backhaul and access components; and (B) decode at least one of said backhaul and access components.

According to yet another embodiment, the present invention is a WCS comprising a plurality of transceivers having one or more wireless relays and one or more base stations, at least one of said wireless relays and at least one of said base stations being adapted to process wireless access traffic and wireless backhaul traffic. Said plurality comprises first and second transceivers and a mobile terminal. The first transceiver is adapted to generate and transmit a superimposed signal having a backhaul component intended for the second transceiver and an access component intended for the mobile terminal. The second transceiver is adapted to receive and decode at least said backhaul component. The mobile terminal is adapted to receive and decode at least said access component.

### BRIEF DESCRIPTION OF THE DRAWINGS

FIG. 1 shows a representative wireless communication system (WCS), in which embodiments of the invention can be practiced;

FIG. 2 shows operation of the WCS of FIG. 1 in accordance with a prior-art communication method;

FIGS. 3A-B illustrate differences in signal attenuation for backhaul and access communication channels in the WCS of FIG. 1;

FIG. 4 shows operation of the WCS of FIG. 1 according to one embodiment of the invention;

FIGS. 5A-C graphically show communication signals that can be used in the communication method shown in FIG. 4 according to one embodiment of the invention;

FIG. 6 shows a flowchart of an adaptive power-adjustment method that is carried out at a mobile terminal (MT) of the WCS shown in FIG. 1 according to one embodiment of the invention;

FIG. 7 shows a flowchart of an adaptive power-adjustment method that is carried out at a base station of the WCS shown in FIG. 1 according to one embodiment of the invention; and

FIG. 8 shows a flowchart of an adaptive power-adjustment method that is carried out at a wireless relay of the WCS shown in FIG. 1 according to one embodiment of the invention.

### DETAILED DESCRIPTION

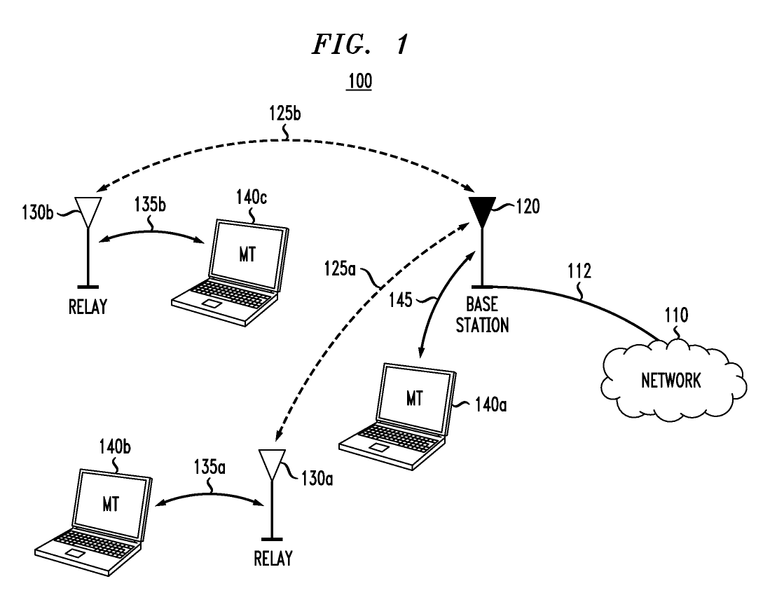

FIG. 1 shows a representative wireless communication system (WCS) 100, in which embodiments of the invention can be practiced. WCS 100 has a base station 120 connected via a wireline communication link 112 to a network 110. WCS 100 further has two wireless relays 130a-b and three mobile terminals (MTs) 140a-c. One skilled in the art will understand that, in a different embodiment, WCS 100 can have a different number of base stations, wireless relays, and/or MTs.

Each of wireless relays 130a-b has a corresponding wireless communication link 125 to base station 120. MT 140a has a wireless communication link 145 to base station 120. MT 140b has a wireless communication link 135a to wireless relay 130a. MT 140c has a wireless communication link 135b to wireless relay 130b. Wireless communication links 125a-b are configured to carry backhaul traffic. Wireless communication links 135a-b and 145 are configured to carry access traffic.

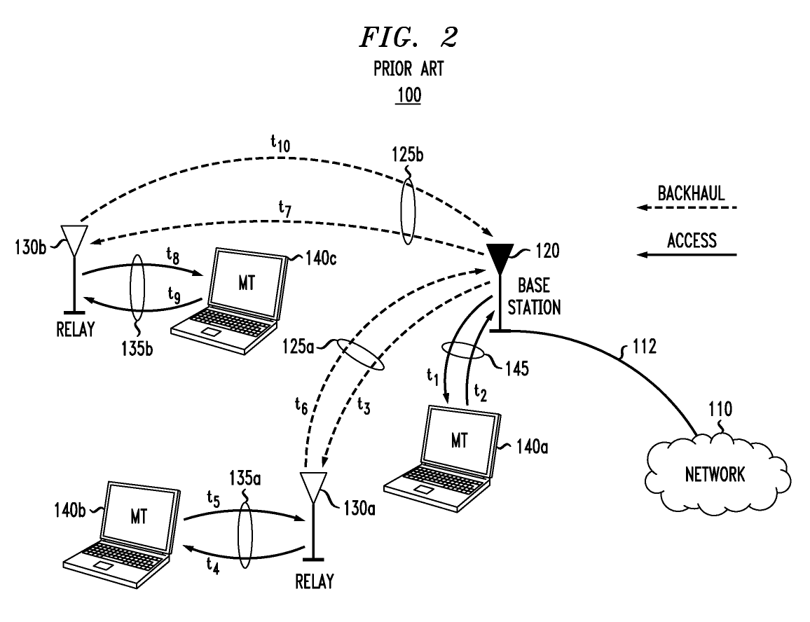

FIG. 2 shows operation of WCS 100 in accordance with a prior-art communication method. More specifically, the communication method of FIG. 2 attempts to minimize inter-signal interference by using time-division multiplexing (TDM) and configuring WCS 100 so that transmissions to/from different entities served by the same base station (in this case, base station 120) take place in different time slots. Uplink and downlink transmissions also occupy different time slots.

FIG. 2 further shows an exemplary communication sequence encompassing ten time slots labeled t1, t2, t3, . . . , t10. During these ten time slots, each of the shown communicating station pairs in WCS 100 exchanges one uplink signal and one downlink signal. For example, in time slot t1, base station 120 sends, via communication link 145, a downlink signal to MT 140a. In time slot t2, MT 140a responds to base station 120 by sending, via communication link 145, an uplink signal. In time slot t3, base station 120 sends to wireless relay 130a, via communication link 125a, a downlink signal intended for MT 140b. In time slot t4, wireless relay 130a relays that downlink signal, via communication link 135a, to MT 140b. In time slot t5, MT 140b responds to wireless relay 130a by sending, via communication link 135a, a corresponding uplink signal. In time slot t6, wireless relay 130a relays the received uplink signal, via communication link 125a, to base station 120. In time slot t7, base station 120 sends to wireless relay 130b, via communication link 125b, a downlink signal intended for MT 140c. In time slot t8, wireless relay 130b relays that downlink signal, via communication link 135b, to MT 140c. In time slot t9, MT 140c responds to wireless relay 130b by sending, via communication link 135b, a corresponding uplink signal. Finally, in time slot t10, wireless relay 130b relays the received uplink signal, via communication link 125b, to base station 120. More details on the communication method shown in FIG. 2 can be found, e.g., in an article by Y. Liang and V. Veeravalli, “Gaussian Orthogonal Relay Channels,” IEEE Transactions on Information Theory, 2005, vol. 51, no. 9, pp. 3284-3289, the teachings of which are incorporated herein by reference.

In the description that follows, it is explained how WCS 100 can be configured to transmit substantially the same amount of information as that transmitted in the communication sequence of FIG. 2 in fewer than ten time slots using a communication method according to one embodiment of the invention. More specifically, this communication method exploits inherent differences in the strengths of backhaul and access communication channels to superimpose some backhaul communication signals onto access communication signals. Herein, the term “channel strength” refers to the amount of signal attenuation in the propagation path between the corresponding transmitter and receiver. Despite some interference between the components of a superimposed signal at an intended receiver, the channel-strength differences enable the receiver to separate the components and successfully recover the encoded data. Advantageously over the above-described prior-art communication method, at least some of the wireless resources that were previously utilized exclusively by backhaul traffic are now made available to access traffic.

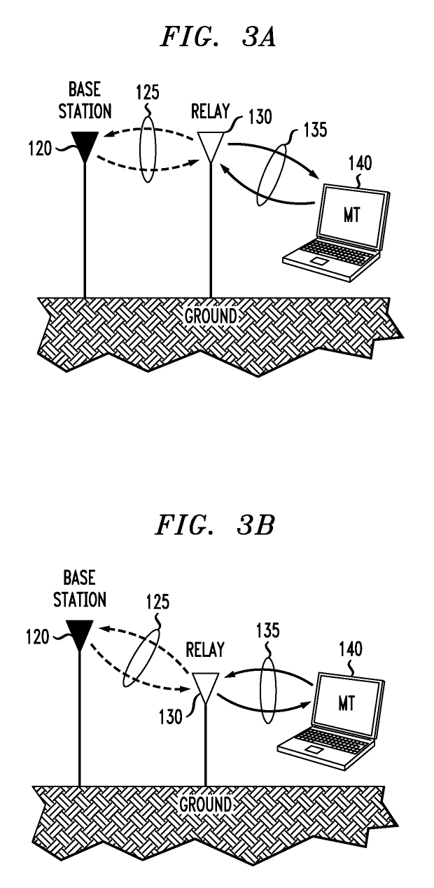

FIGS. 3A-B illustrate typical differences in signal attenuation for backhaul and access communication channels in WCS 100. More specifically, each of FIGS. 3A-B shows a schematic side view of a portion of WCS 100, indicating the elevation above the ground level of various stations in that portion. Base stations, such as base station 120, are typically installed in elevated positions, such as on towers or rooftops, which place them above the propagation clutter formed by buildings, trees, vehicles, etc. Users, on the other hand, typically operate their wireless communication devices, such as MT 140, near the ground level, which places them within the propagation clutter. Wireless relays, such as wireless relay 130, may be installed either above the propagation clutter, as shown in FIG. 3A, or within it, as shown in FIG. 3B. In either case, backhaul communication link 125 is subjected to less propagation clutter than its counterpart access communication link 135. Typically, the difference in the resulting attenuation of backhaul and access signals in the corresponding communication channels can be between about 10 dB and about 30 dB.

In FIG. 3A, backhaul communication link 125 is substantially above the propagation clutter. In contrast, access communication link 135 is at least partially within the propagation clutter. As a result, the attenuation of access signals in communication link 135 is significantly greater than the attenuation of backhaul signals in communication link 125.

In FIG. 3B, backhaul communication link 125 is at least partially above the propagation clutter. In contrast, access communication link 135 is substantially within the propagation clutter. Consequently, similar to the situation of FIG. 3A, communication links 125 and 135 shown in FIG. 3B also subject their respective signals to very different amounts of attenuation.

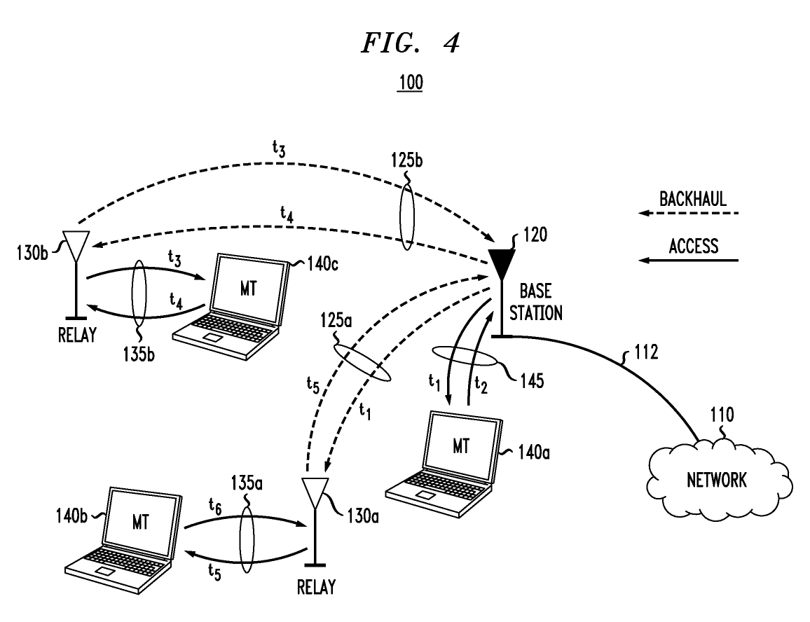

FIG. 4 shows operation of WCS 100 according to one embodiment of the invention. More specifically, FIG. 4 shows an exemplary communication sequence, during which, as in FIG. 2, each of the shown communicating station pairs in WCS 100 exchanges one uplink signal and one downlink signal. However, advantageously over the communication method of FIG. 2, the communication method of FIG. 4 enables WCS 100 to complete the exchange in six, instead of ten, time slots.

The communication method of FIG. 4 exploits the above-indicated differences in the amounts of signal attenuation in backhaul and access communication links by using superposition transmission. More specifically, two signals are superimposed and transmitted during the same time slot and on the same bandwidth. A superimposed signal contains a backhaul signal and an access signal. Typically, the power of the transmitter(s) is partitioned between these signals so that the backhaul signal is weaker than the access signal. The relatively low signal attenuation in the backhaul communication link enables the intended backhaul-signal receiver to successfully receive and decode the relatively weak backhaul signal. On the other hand, for the intended access-signal receiver, the relatively weak backhaul signal represents a small amount of additional noise/interference that does not significantly affect its ability to successfully receive and decode the relatively strong access signal.

Using superimposed signals, an uplink/downlink exchange between the stations of WCS 100 can be executed, for example, as follows. In time slot t1, base station 120 sends a superimposed signal having a downlink backhaul signal intended for wireless relay 130a and a downlink access signal intended for MT 140a. Due to the relatively low signal attenuation in communication link 125a, wireless relay 130a can successfully receive and decode the relatively weak downlink backhaul signal. On the other hand, MT 140a is also able to successfully receive and decode the downlink access signal, for example, by treating the superimposed relatively weak downlink backhaul signal as noise or interference. In time slot t2, MT 140a responds to base station 120 by sending an uplink access signal.

In time slot t3, wireless relay 130b sends a superimposed signal having an uplink backhaul signal intended for base station 120 and a downlink access signal intended for MT 140c. Due to the relatively low signal attenuation in communication link 125b, base station 120 can successfully receive and decode the relatively weak uplink backhaul signal. On the other hand, MT 140c is also able to successfully receive and decode the downlink access signal, for example, by treating the superimposed relatively weak uplink backhaul signal as noise or interference.

In time slot t4, base station 120 sends a downlink backhaul signal intended for wireless relay 130b. Also in time slot t4, MT 140c responds to wireless relay 130b by sending an uplink access signal. The two signals collide, thereby creating a corresponding superimposed signal at wireless relay 130b. Provided that base station 120 and MT 140c allocate appropriate power to the downlink backhaul signal and the uplink access signal, respectively, wireless relay 130b is able to successfully decode both of these signals, e.g., using the “successive detection” method described in more detail below.

In time slot t5, wireless relay 130a sends a superimposed signal having an uplink backhaul signal intended for base station 120 and a downlink access signal intended for MT 140b. Due to the relatively low signal attenuation in communication link 125a, base station 120 can successfully receive and decode the relatively weak uplink backhaul signal. On the other hand, MT 140b is also able to successfully receive and decode the downlink access signal, for example, by treating the superimposed relatively weak uplink backhaul signal as noise or interference. In time slot t6, MT 140b responds to wireless relay 130a by sending an uplink access signal.

Comparing FIGS. 2 and 4, one finds that transmission of superimposed signals enables WCS 100 to use fewer time slots for an uplink/downlink exchange. For the specific examples described above, the number of time slots has been reduced from ten down to six. More generally, in an uplink/downlink exchange similar to that shown in FIGS. 2 and 4, two time slots can potentially be saved for every MT 140 connected to a wireless relay 130.

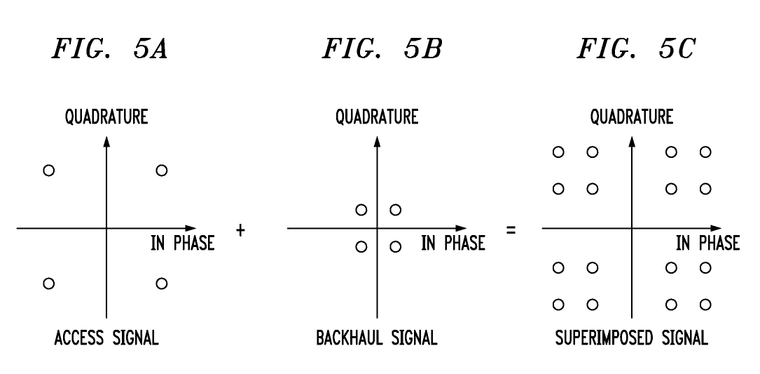

FIGS. 5A-C graphically show communication signals that can be used in the communication method of FIG. 4 according to one embodiment of the invention. More specifically, FIGS. 5A-C graphically show access, backhaul, and superimposed signals, respectively. Both the access and backhaul signals are generated using quadrature phase shift keying (QPSK) modulation, and FIGS. 5A-B depict those signals in the corresponding complex planes. The larger amplitude of the access signal relative to that of the backhaul signal is indicated by the greater separation between the QPSK constellation points in FIG. 5A than in FIG. 5B. A superposition of the two signals results in a new constellation having sixteen constellation points (see FIG. 5C). Those sixteen constellation points are composed of four quartets, each having a corresponding QPSK constellation point of the access signal that is split four ways due to the presence of the backhaul signal.

In one embodiment, a receiver, such as base station 120, wireless relay 130, or MT 140, can decode the superimposed signal (FIG. 5C) and recover the data carried by the constituent access and/or backhaul signals (FIGS. 5A-B) using a detection method hereafter referred to as “successive detection.” A first step of successive detection detects the stronger access signal by substantially treating the superimposed backhaul signal as noise. More specifically, during receiver training, locations on the complex plane of the constellation points for the access signal are determined by clustering together the points of each corresponding quartet. Slicing thresholds are then set based on the determined locations. During regular operation, the slicing thresholds are used to make slicing decisions and recover the data carried by the constituent access signals.

A second step of successive detection detects the weaker backhaul signal using the detection results of the first step. More specifically, based on the slicing decision of the first step, an estimated contribution of the access signal into the superimposed signal is first calculated. The estimated contribution is then subtracted from the superimposed signal to obtain an estimated backhaul signal. Finally, the latter is processed in a conventional manner to recover the data encoded onto the backhaul signal.

One skilled in the art will appreciate that the second step of successive detection may be omitted if the receiver is configured to receive access traffic only. For example, MT 140a may omit the second step of successive detection for time slot t1 (see FIG. 4). Similarly, MT 140b and 140c may omit the second step of successive detection for time slots t5 and t3, respectively. However, both steps of successive detection are carried out at wireless relay 130a for time slot t1 and at base station 120 for time slots t3 and t5, respectively, to detect the corresponding backhaul signals.

In another embodiment, a receiver, such as base station 120, wireless relay 130, or MT 140, can decode the superimposed signal (FIG. 5C) and recover the data carried by the constituent access and/or backhaul signals (FIGS. 5A-B) using a detection method hereafter referred to as “joint detection.” Joint detection detects the superimposed signal (FIG. 5C) as if it were generated using 16-ary quadrature amplitude modulation (16-QAM). In each time slot, the superimposed signal is appropriately sliced to determine which 16-QAM symbol it corresponds to. The data carried by the constituent access and backhaul signals are then inferred from that 16-QAM symbol. The receiver can discard the data corresponding to the unwanted constituent signal and retain the data corresponding to the wanted one.

The actual difference in the strengths of backhaul and access communication channels in WCS 100 depends on the location and environment of the corresponding MTs 140. The relative channel strengths can vary over time, e.g., if MT 140 moves and/or its environment changes. To keep the power of a superimposed signal appropriately (and preferably optimally) partitioned between the constituent access and backhaul signals at the intended receiver(s), WCS 100 is configured to adaptively change the transmitted signal power at the corresponding transmitter(s). Generally, it is beneficial to keep a constituent backhaul signal as weak as possible while still rendering it detectable at the intended receiver, because this approach tends to minimize the amount of “noise” or interference that the backhaul signal presents for the detection of the corresponding access signal. A description that follows outlines representative procedures that can be used in WCS 100 to implement such adaptive power adjustments.

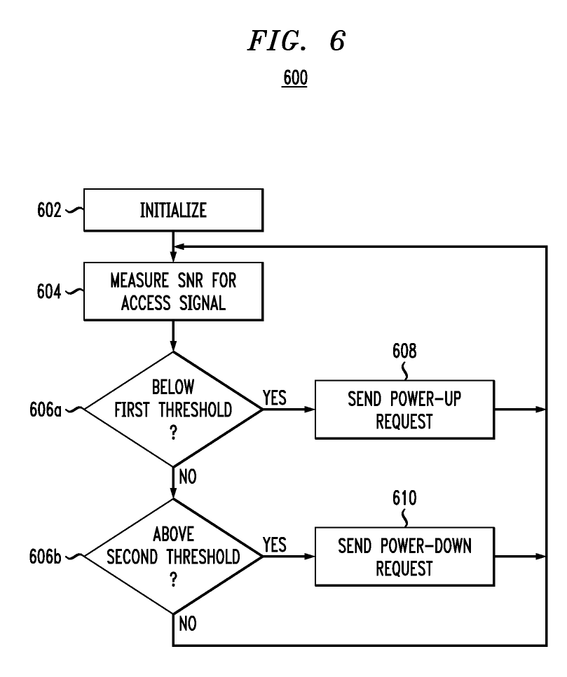

FIG. 6 shows a flowchart of an adaptive power-adjustment method 600 that is carried out at MT 140 according to one embodiment of the invention. Method 600 enables MT 140 to provide feedback to the corresponding wireless relay 130 or base station 120 regarding power allocations between the constituent backhaul and access signals in a superimposed signal intended for that MT.

At step 602, MT 140 initializes method 600. At step 604, MT 140 receives a superimposed signal transmitted by the corresponding wireless relay 130 or base station 120. MT 140 detects the received signal, e.g., as described above, and determines signal-to-noise ratio (SNR) for the constituent access signal. To make this determination, MT 140 considers the constituent backhaul signal to be “noise.” At steps 606a-b, MT 140 compares the determined SNR with at least first and second threshold values. Depending on the comparison results, MT 140 might send a power-up or power-down request to the corresponding wireless relay 130 or base station 120.

If the SNR determined at step 604 is below the first threshold value, then the processing of method 600 is directed to step 608, at which MT 140 requests that the power allocated to the constituent access signal be increased. If the determined SNR is above the second threshold value (greater than the first threshold value), then the processing of method 600 is directed to step 610, at which MT 140 requests that the power allocated to the constituent access signal be decreased. After the execution of either one of steps 608 and 610, the processing of method 600 is directed back to step 604. If the determined SNR falls between the first and second threshold values, then steps 608 and 610 are bypassed and the processing of method 600 returns to step 604.

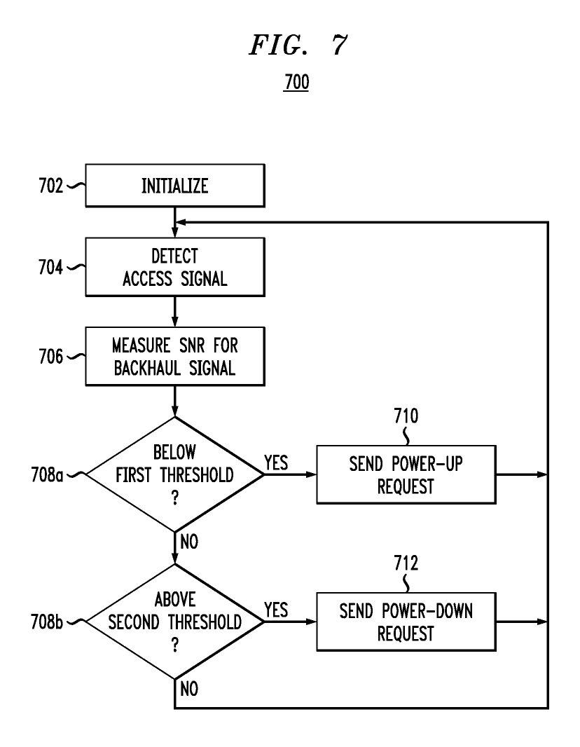

FIG. 7 shows a flowchart of an adaptive power-adjustment method 700 that is carried out at base station 120 according to one embodiment of the invention. Method 700 applies to uplink backhaul traffic and enables base station 120 to provide feedback to the corresponding wireless relay 130 regarding power allocations between the constituent backhaul and access signals in the superimposed signal intended for the base station. Note that, in method 700 base station 120 is configured to perform successive detection.

At step 702, base station 120 initializes method 700. At step 704, base station 120 receives a superimposed signal transmitted by the corresponding wireless relay 130. Using the first step of successive detection, base station 120 detects the constituent access signal. At step 706, using the second step of successive detection, base station 120 detects the constituent backhaul signal and determines the SNR corresponding to that signal. At steps 708a-b, base station 120 compares the determined SNR with at least first and second threshold values. Note that the first and second thresholds used in method 700 may or may not be different from the first and second thresholds used in method 600. Depending on the comparison results, base station 120 might send a power-up or power-down request to the corresponding wireless relay 130.

If the SNR determined at step 706 is below the first threshold value, then the processing of method 700 is directed to step 710, at which base station 120 requests that the power allocated to the constituent backhaul signal be increased. If the determined SNR is above the second threshold value (greater than the first threshold value), then the processing of method 700 is directed to step 712, at which base station 120 requests that the power allocated to the constituent backhaul signal be decreased. After the execution of either one of steps 710 and 712, the processing of method 700 is directed back to step 704. If the determined SNR falls between the first and second threshold values, then steps 710 and 712 are bypassed and the processing of method 700 returns to step 704.

Although method 700 has been described in reference to uplink backhaul traffic, one skilled in the art will recognize that a similar adaptive power-adjustment method can be used for downlink backhaul traffic. More specifically, in the case of downlink backhaul traffic, base station 120 is configured to generate superimposed signals intended for wireless relay 130, whereas it is vice versa in method 700. Therefore, a proper description of the adaptive power-adjustment method for downlink backhaul traffic can be obtained from the above description of method 700 by swapping the roles of base station 120 and wireless relay 130. For example, in the steps analogous to steps 710 and 712, the power-up and power-down requests are now sent from wireless relay 130 to base station 120.

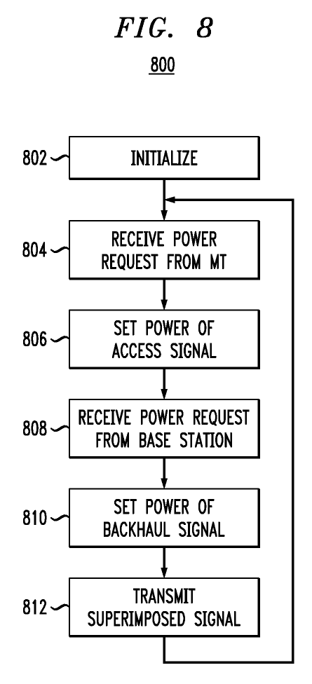

FIG. 8 shows a flowchart of an adaptive power-adjustment method 800 that is carried out at wireless relay 130 according to one embodiment of the invention. Method 800 enables wireless relay 130 to use the feedback generated by the corresponding MT 140 and base station 120, respectively, to set the total power of the transmitted superimposed signal and to allocate that power between the constituent backhaul and access signals. The feedback signals used in method 800 can be generated, e.g., using methods 600 and 700.

At step 802, wireless relay 130 initializes method 800. At step 804, wireless relay 130 receives a power request from the corresponding MT 140. At step 806, based on the power request received at step 804, wireless relay 130 sets the power for the access signal. At step 808, wireless relay 130 receives a power request from the corresponding base station 120. At step 810, based on the power request received at step 808, wireless relay 130 sets the power for the backhaul signal. At step 812, wireless relay 130 uses the power values of steps 806 and 810 to generate and transmit the corresponding superimposed signal. Thereafter, the processing of method 800 returns to step 804.

One skilled in the art will recognize that, if no power requests are received from MT 140 and/or base station 120, then the corresponding one or both of steps 804 and 808 can be skipped. In that case, steps 806 and 810 are carried out using either default or previously set power values. One skilled in the art will recognize that a method analogous to method 800 can similarly be used at base station 120 when the base station is configured to generate superimposed signals. A proper description of this analogous method can be obtained from the above description of method 800 by swapping the roles of base station 120 and wireless relay 130.

Although embodiments of the invention have been described in reference to TDM, the invention is not so limited. One skilled in the art will appreciate that a similar approach can be applied to other multiplexing techniques, e.g., frequency division multiplexing (FDM), spreading codes, and/or any combination thereof. For example, in TDM, the time axis is partitioned into distinct time slots and some of the time slots are used for the generation of superimposed signals having backhaul and access signal components. Similarly, in embodiments that utilize FDM, the frequency axis is partitioned into distinct frequency bands and some of the frequency bands are used for the generation of superimposed signals having backhaul and access signal components. Furthermore, in embodiments that utilize signal multiplexing based on spreading codes, the mathematical space of spreading codes is partitioned into distinct non-overlapping orthogonal code subspaces and some of the code subspaces are used for the generation of superimposed signals having backhaul and access signal components.

While this invention has been described with reference to illustrative embodiments, this description is not intended to be construed in a limiting sense. Various modifications of the described embodiments, as well as other embodiments of the invention, which are apparent to persons skilled in the art to which the invention pertains are deemed to lie within the principle and scope of the invention as expressed in the following claims.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a radio transceiver, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, the machine becomes an apparatus for practicing the invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

What is claimed is:

1. At a first transceiver of a wireless communication system (WCS) comprising a plurality of transceivers having one or more wireless relays and one or more base stations, at least one of said wireless relays and at least one of said base stations being adapted to process wireless access traffic and wireless backhaul traffic, a communication method comprising:
generating a superimposed signal having a backhaul component intended for a second transceiver and an access component intended for a mobile terminal; and
transmitting the generated superimposed signal.

2. The invention of claim 1, wherein said step of generating comprises allocating power between said backhaul and access components based on signal propagation conditions between the first and second transceivers and between the first transceiver and the mobile terminal to render the backhaul component decodable at the second transceiver and the access component decodable at the mobile terminal.

3. The invention of claim 1, wherein:
the first transceiver is a base station; and
the second transceiver is a wireless relay.

4. The invention of claim 1, wherein:
the first transceiver is a wireless relay; and
the second transceiver is a base station or another wireless relay.

5. The invention of claim 1, wherein:
the first transceiver is adapted to transmit signals using time division multiplexing; and
an instance of the superimposed signal is transmitted in a single time slot.

6. The invention of claim 1, wherein:
the first transceiver is adapted to transmit signals using frequency division multiplexing; and
the superimposed signal has at least one frequency component used by both of the backhaul and access components.

7. The invention of claim 1, wherein:
the first transceiver is adapted to transmit signals using signal multiplexing based on spreading codes; and
the superimposed signal is generated using at least one spreading-code subspace for both of the backhaul and access components.

8. The invention of claim 1, wherein at least one of the second transceiver and the mobile terminal is adapted to:
define an extended constellation based on constellations corresponding to the backhaul and access components;
process the received superimposed signal using said extended constellation; and
recover data encoded onto at least one of the backhaul and access components based on said processing.

9. The invention of claim 1, further comprising receiving a power request from at least one of the mobile terminal and the second transceiver, wherein said step of generating comprises setting the power of at least one of said backhaul and access components based on the received power request.

10. At a first transceiver of a wireless communication system (WCS) comprising a plurality of transceivers having one or more wireless relays and one or more base stations, at least one of said wireless relays and at least one of said base stations being adapted to process wireless access traffic and wireless backhaul traffic, a communication method comprising:
receiving a superimposed signal having a backhaul component and an access component, said superimposed signal generated by (i) a second transceiver or (ii) by the second transceiver and another transceiver, with each of the second transceiver and said another transceiver generating a corresponding one of the backhaul and access components; and
decoding at least one of said backhaul and access components.

11. The invention of claim 10, wherein:
the superimposed signal is generated by the second transceiver; and
power between said backhaul and access components has been allocated based on signal propagation conditions between the second and first transceivers and between the second transceiver and a third transceiver to render an intended one of said backhaul and access components decodable at the first transceiver and the other one of said backhaul and access components decodable at the third transceiver.

12. The invention of claim 11, wherein:
the first transceiver is a base station;
the second transceiver is a wireless relay; and
the third transceiver is a mobile terminal.

13. The invention of claim 11, wherein:
the first transceiver is a wireless relay;
the second transceiver is a base station or another wireless relay; and
the third transceiver is a mobile terminal.

14. The invention of claim 11, wherein:
the first transceiver is a mobile terminal;
the second transceiver is a wireless relay; and
the third transceiver is a base station or another wireless relay.

15. The invention of claim 10, wherein:
the superimposed signal is generated by the second transceiver and said another transceiver; and
power between said backhaul and access components has been allocated based on signal propagation conditions between the second and first transceivers and between said another transceiver and the first transceiver to render both of said backhaul and access components decodable at the first transceiver.

16. The invention of claim 10, the step of decoding comprises decoding the access component while treating the backhaul component as noise.

17. The invention of claim 16, further comprising:
estimating a contribution of the access component into the superimposed signal based on data decoded from the access component;
subtracting said estimated contribution from the superimposed signal to estimate the backhaul component; and
recovering data encoded onto the backhaul component based on the estimated backhaul component.

18. The invention of claim 17, further comprising:
measuring a signal-to-noise ratio (SNR) for the estimated backhaul component; and
sending to the second transceiver a power-up or power-down request for a next instance of the backhaul component based on the measured SNR.

19. The invention of claim 16, further comprising:
measuring a signal-to-noise ratio (SNR) for the decoded access component; and
sending to the second transceiver a power-up or power-down request for a next instance of the access component based on the measured SNR.

20. The invention of claim 10, further comprising:
defining an extended constellation based on constellations corresponding to the backhaul and access components;
processing the received superimposed signal using said extended constellation; and
recovering data encoded onto at least one of the backhaul and access components based on said processing.

21. The invention of claim 20, further comprising discarding the data corresponding to said other one component.

22. A first transceiver of a wireless communication system (WCS) comprising a plurality of transceivers having one or more wireless relays and one or more base stations, at least one of said wireless relays and at least one of said base stations being adapted to process wireless access traffic and wireless backhaul traffic, said first transceiver characterized by being adapted to:
generate a superimposed signal having a backhaul component intended for a second transceiver and an access component intended for a mobile terminal; and
transmit the generated superimposed signal.

23. A first transceiver of a wireless communication system (WCS) comprising a plurality of transceivers having one or more wireless relays and one or more base stations, at least one of said wireless relays and at least one of said base stations being adapted to process wireless access traffic and wireless backhaul traffic, said first transceiver characterized by being adapted to:
receive a superimposed signal having a backhaul component and an access component, said superimposed signal generated by (i) a second transceiver or (ii) by the second transceiver and another transceiver, with each of the second transceiver and said another transceiver generating a corresponding one of the backhaul and access components; and
decode at least one of said backhaul and access components.

24. A wireless communication system (WCS), comprising a plurality of transceivers having one or more wireless relays and one or more base stations, at least one of said wireless relays and at least one of said base stations being adapted to process wireless access traffic and wireless backhaul traffic, wherein:
said plurality comprises first and second transceivers and a mobile terminal;
the first transceiver is adapted to generate and transmit a superimposed signal having a backhaul component intended for the second transceiver and an access component intended for the mobile terminal;
the second transceiver is adapted to receive and decode at least said backhaul component; and
the mobile terminal is adapted to receive and decode at least said access component.
